(19) United States
(12) Patent Application Publication
(10) Pub. No.: US 2014/0043858 A1
(43) Pub. Date: Feb. 13, 2014

(54) LIGHT GUIDE PLATE AND DISPLAY DEVICE HAVING THE SAME

(71) Applicant: SAMSUNG DISPLAY CO., LTD., Yongin-City (KR)

(72) Inventor: Nam Jin Jang, Buk-gu (KR)

(73) Assignee: SAMSUNG DISPLAY CO., LTD., Yongin-City (KR)

(21) Appl. No.: 13/754,296

(22) Filed: Jan. 30, 2013

(30) Foreign Application Priority Data
Aug. 8, 2012 (KR) 10-2012-0086880

(51) Int. Cl. F21V 8/00

(52) U.S. Cl. CPC G02B 6/0011
USPC 362/613; 362/628

(57) ABSTRACT

Light guide plate and a display device having the same. According to an aspect of the present invention, there is provided a display device comprising a light guide plate (LGP) comprising a base, sidewalls which protrude from a surface of the base, and covers which protrude towards a center of the base, and a display panel disposed on the LGP.

### CLAIM OF PRIORITY

This application claims priority from Korean Patent Application No. 10-2012-0086880 filed on Aug. 8, 2012 in the Korean Intellectual Property Office, the disclosure of which is incorporated herein by reference in its entirety.

### BACKGROUND OF THE INVENTION

1. Field of the Invention

The present invention relates to a light guide plate and a display device having the same.

2. Description of the Related Art

A display device is a device that displays an image. A liquid crystal display (LCD), which is now being widely used, is a light-receiving device and employs a backlight assembly for providing light to the LCD. The backlight assembly may include a light guide plate (LGP) which guides incident light as its component. The light guide plate is generally made out of a transparent material and serves to receive light from a line-shaped light source at an edge of the plate and produces a uniform, plate-shaped light source on a major surface of the plate. In forming an LCD display, one or more optical sheets may be placed on a surface of the LGP. The optical sheets may modulate optical characteristics of emitted light.

To ensure optical display quality, the optical sheets should be aligned as accurately as desired. The movement of the optical sheets hinders the alignment of the optical sheets. To prevent the movement of the optical sheets, the optical sheets may be aligned in a mold frame. In this case, however, a stacking process may be added, the thickness of the LCD may be increased by more than the thickness of the mold frame, and a portion of a display area in which the mold frame is placed may be sacrificed.

### SUMMARY OF THE INVENTION

Aspects of the present invention provide a display device in which optical sheets are easily and securely fixed in position and the utilization area of the optical sheets is maximized.

Aspects of the present invention also provide a light guide plate (LGP) which easily and securely fixes optical sheets in position, however, aspects of the present invention are not restricted to the one set forth herein. The above and other aspects of the present invention will become more apparent to one of ordinary skill in the art to which the present invention pertains by referencing the detailed description of the present invention given below.

According to an aspect of the present invention, there is provided a display device comprising a light guide plate (LGP) including a light guide plate (LGP) including a base, a plurality of sidewalls that protrude from a surface of the base, and a plurality of covers that protrude towards a center of the base and a display panel arranged on the LGP. The base may have a rectangular shape, and the plurality of sidewalls may protrude upward from edges of the surface of the base. The plurality of covers may be arranged at locations corresponding to corners of the base. The display device may also include at least one light source arranged to face at least one side surface of the base, the LGP may also include at least one protrusion that protrudes toward the at least one light source. Each of the at least one protrusion may be arranged at a corresponding corner of the base. The plurality of sidewalls may be perpendicular to the surface of the base. The plurality of covers may extend parallel to the surface of the base. The display device may also include at least one optical sheet stacked on the surface of the base. The at least one optical sheet may contact the plurality of sidewalls. A height of each of the plurality of sidewalls may be greater than a height of the at least one optical sheet. The at least one optical sheet may be at least partially overlapped by the plurality of covers. The at least one optical sheet may contact at least a portion of each of the plurality of covers. The display device may also include a housing accommodating the display panel and the LGP and an adhesive member attaching the LGP to the housing. The adhesive member may be attached to at least a part of an outer surface of at least one of the plurality of sidewalls. The base, the plurality of sidewalls, and the plurality of covers may be formed integrally with each other.

According to another aspect of the present invention, there is provided a display device that includes a light guide plate (LGP) including a base and a plurality of sidewalls that protrude from edges of the base and are also bent towards a center of the base and a display panel arranged on the LGP. The plurality of sidewalls may protrude upward in a ‘C’ shape. The display device may also include at least one optical sheet arranged on a surface of the base that may be surrounded by the plurality of sidewalls. The plurality of sidewalls may at least partially overlap the at least one optical sheet.

According to yet another aspect of the present invention, there is provided a display device that includes a base, a plurality of sidewalls protruding from a surface of the base and a plurality of covers protruding from the plurality of sidewalls toward a center of the base.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is an exploded perspective view of a display device according to an embodiment of the present invention;

FIG. 2 is a perspective view of a light guide plate (LGP) shown in FIG. 1;

FIG. 3 is a plan view of the LGP shown in FIG. 2;

FIG. 4 is a cross-sectional view of the display device taken along the line IV-IV′ of FIG. 1;

FIG. 5 is a cross-sectional view of a display device according to another embodiment of the present invention, taken as in FIG. 4;

FIG. 6 is a plan view of an LGP according to another embodiment of the present invention;

FIG. 7 is a plan view of an LGP according to another embodiment of the present invention;

FIG. 8 is a plan view of an LGP according to another embodiment of the present invention;

FIG. 9 is a plan view of an LGP according to another embodiment of the present invention;

FIG. 10 is a plan view of an LGP according to another embodiment of the present invention; and

FIG. 11 is a cross-sectional view of a display device according to another embodiment of the present invention, taken as in FIG. 4.

### DETAILED DESCRIPTION OF THE INVENTION

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Thus, in some embodiments, well-known structures and devices are not shown in order not to obscure the description of the invention with unnecessary detail. Like numbers refer to like elements throughout. In the drawings, the thickness of layers and regions are exaggerated for clarity.

It will be understood that when an element or layer is referred to as being “on,” or “connected to” another element or layer, it can be directly on or connected to the other element or layer or intervening elements or layers may be present. In contrast, when an element is referred to as being “directly on” or “directly connected to” another element or layer, there are no intervening elements or layers present. As used herein, the term “and/or” includes any and all combinations of one or more of the associated listed items.

Spatially relative terms, such as “below,” “beneath,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

Embodiments described herein will be described referring to plan views and/or cross-sectional views by way of ideal schematic views of the invention. Accordingly, the exemplary views may be modified depending on manufacturing technologies and/or tolerances. Therefore, the embodiments of the invention are not limited to those shown in the views, but include modifications in configuration formed on the basis of manufacturing processes. Therefore, regions exemplified in figures have schematic properties and shapes of regions shown in figures exemplify specific shapes of regions of elements and not limit aspects of the invention.

Hereinafter, embodiments of the present invention will now be described with reference to the attached drawings.

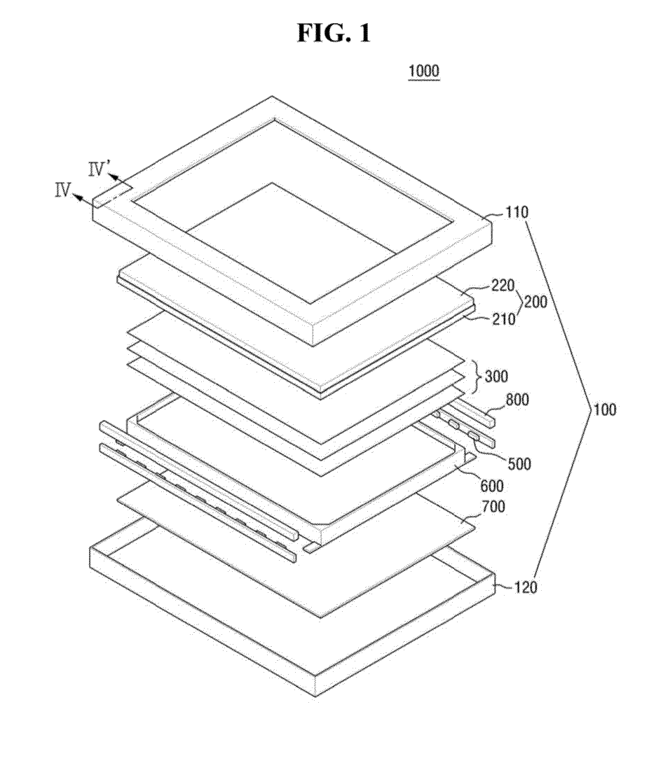

Turning now to FIG. 1, FIG. 1 is an exploded perspective view of a display device 1000 according to an embodiment of the present invention. Referring to FIG. 1, the display device 1000 includes a display panel 200 and a light guide plate (LGP) 600.

The display panel 200 is a panel that displays an image and may be a liquid crystal display (LCD) panel, an electrophoretic display panel, an organic light-emitting diode (OLED) panel, a light-emitting diode (LED) panel, an inorganic electroluminescent (EL) display panel, a field emission display (FED) panel, a surface-conduction electron-emitter display (SED) panel, a plasma display panel (PDP), or a cathode ray tube (CRT) display panel. Hereinafter, an LCD will be described as an example of the display device 1000 according to the current embodiment, and an LCD panel will also be described as an example of the display panel 200, however, the display device 1000 and the display panel 200 according to the present invention are not limited to the above examples. Various types of display devices can be used as the display device 1000, and various types of display panels can be used as the display panel 200.

The display panel 200 may include a first substrate 210, a second substrate 220 which faces the first substrate 210, and a liquid crystal layer which is interposed between the first substrate 210 and the second substrate 220. The first substrate 210 may be a thin-film transistor (TFT) substrate which includes a plurality of TFTs. The second substrate 220 may be a counter substrate including a color filter layer.

On the whole, the display panel 200 may be shaped like a rectangular parallelepiped. The LGP 600 and/or one or more optical sheets 300, which will be described later, may have a shape corresponding to the shape of the display panel 200.

The LGP 600 is disposed under the display panel 200. The LGP 600 is generally made out of a transparent material, such as but not limited to an acrylic material including poly (methyl methacrylate) (i.e. PMMA), and serves to receive light from one or more line-shaped or dot light sources at one or more edges of a plate, and produce a uniform, plate-shaped light source on a whole major surface of the plate of the LGP, thereby guiding incident light toward the display panel 200. On a bottom face of the LGP may include a dot matrix, a line matrix, or V-cutting scratched therein to guide an optical path and scatter the light from the one or more line or dot light sources. The LGP 600 is often used as a backlight for a LCD panel, and is necessary because it maximizes the uniformity of light, is embodied in a slim structure, and serves to reorient the line or dot light sources, such as fluorescent, decoration lamp or a LED into a plate light source. The specific configuration of the LGP 600 will be described later.

The display device 1000 according to the current embodiment may further include light sources 500, the optical sheets 300, a reflective sheet 700, a housing 100, and an adhesive member 800.

The light sources 500 may be disposed on at least one side of the LGP 600. The light sources 500 may be, for example, light-emitting diodes (LEDs), cold cathode fluorescent lamps (CCFLs), hot cathode fluorescent lamps (HCFLs), or external electrode fluorescent lamps (EEFLs). In FIG. 1, a display device including an edge-type backlight assembly in which the light sources 500 are disposed on at least one side of the LGP 600 is shown as an example of the display device 1000, however, the present invention is not limited thereto. A display device including a direct-type backlight assembly in which the light sources 500 are disposed under the LGP 600 is also applicable as the display device 1000.

The optical sheets 300 may be placed on a surface of the LGP 600. The optical sheets 300 have optical modulation functions, and the number of the optical sheets 300 may be equal to or greater than one. Each of the optical sheets 300 may having an optical modulation function such as diffusion, light concentration, reflection polarization, circular polarization, phase difference compensation, or the like. The optical sheets 300 may be one or more of a polarizing film, a diffusion film, a reflective polarizing film, a protective film, a phase difference film, and a luminance enhancing film.

The reflective sheet 700 may be disposed on the other surface of the LGP 600. The reflective sheet 700 reflects light, which is output downward from the other surface of the LGP 600, in an upward direction. The reflective sheet 700 may include a material layer with reflexibility, for example, a metal layer.

The housing 100 may accommodate the display panel 200, the LGP 600, the light sources 500, the optical sheets 300, and the reflective sheet 700 described above. The housing 100 may include a lower housing 120 and an upper housing 110. The lower housing 120 may be disposed under the reflective sheet 700, and the upper housing 110 may be disposed on the display panel 200. The upper housing 110 may include a window that defines a display area. The upper housing 110 may be coupled to the lower housing 120 to surround sidewalls of the lower housing 120.

The adhesive member 800 may be disposed between the lower housing 120 and at least one side surface of the LGP 600. The adhesive member 800 may securely fix the LGP 600 to the housing 100. The specific configuration of the adhesive member 800 will be described later.

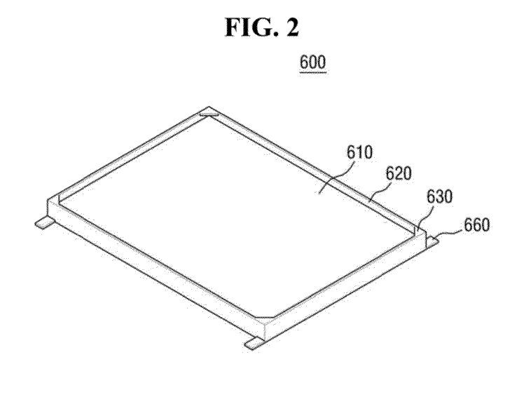

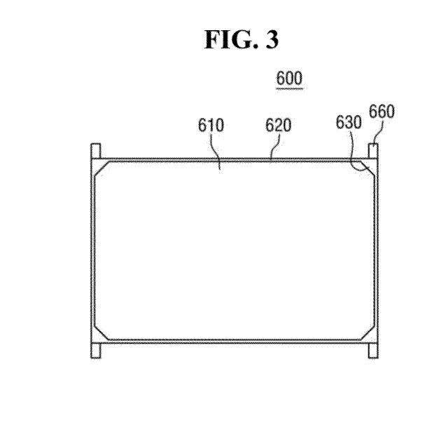

Turning now to FIGS. 2 and 3, the LGP 600 of FIG. 1 will now be described in more detail. FIG. 2 is a perspective view of the LGP 600 shown in FIG. 1 and FIG. 3 is a plan view of the LGP 600 shown in FIG. 2.

The LGP 600 includes a base 610, sidewalls 620 which protrude from a surface of the base 610, and covers 630 which protrude from the sidewalls 620 toward a center of the base 610. The base 610 may be plate-shaped. In FIGS. 2 and 3, the base 610 is shaped like a rectangular parallelepiped, however, in another exemplary embodiment, the base 610 may be shaped like a wedge which becomes gradually thinner from one end to the other end thereof.

The sidewalls 620 may protrude vertically upward from the surface of the base 610. In addition, the sidewalls 620 may protrude perpendicularly to the surface of the base 610. The sidewalls 620 may be formed in an edge region adjacent to sides of the base 610. In an exemplary embodiment, the sidewalls 620 may be formed continuously along all edges of the base 610. The sidewall 620 at each side of the base 610 may have a uniform height. The sidewalls 620 at different sides of the base 610 may have an equal height, however, the present invention is not limited thereto.

Outer surfaces of the sidewalls 620 may be parallel to side surfaces of the base 610. Further, the outer surfaces of the sidewalls 620 may lie in the same plane with the side surfaces of the base 610. Inner surfaces of the sidewalls 620 may define a housing space together with the surface of the base 610. Upper surfaces of all sidewalls 620 may lie in the same plane and may be parallel to the surface of the base 610.

The covers 630 may protrude from the inner surfaces of the sidewalls 620 toward the center of the base 610. In an exemplary embodiment, the covers 630 may be formed at corners where the sidewalls 620 cross each other. The covers 630 may protrude horizontally and parallel to the surface of the base 610. Upper surfaces of the covers 630 may be located on extension surfaces of the upper surfaces of the sidewalls 620. In a plan view of the LGP 600 of FIG. 3, the covers 630 are illustrated as being triangular.

The base 610, the sidewalls 620, and the covers 630 may all be made of the same material. Further, the base 610, the sidewalls 620, and the covers 630 may be formed integrally with each other.

The LGP 600 may include one or more protrusions 660 which protrude from at least one side surface of the base 610. The protrusions 660 may be formed at the corners of the base 610. The protrusions 660 may protrude perpendicularly to at least one side surface of the base 610. Each of the protrusions 660 may be shaped like a rectangular parallelepiped. In FIG. 1, each of the protrusions 660 is shaped like a rectangular parallelepiped, however, each of the protrusions 660 can be manufactured in various shapes including a cylindrical shape. The protrusions 660 may be inserted into grooves of the lower housing 120 shown in FIG. 1, thereby fixing the LGP 600 and the lower housing 120 to each other. A side surface of the base 610 on which the protrusions 660 are formed may be placed to face the light sources 500 shown in FIG. 1. A side surface of the base 610 which does not face the light sources 500 may not have the protrusions 660 and may be flat. In this case, light emitted from the light sources 500 may be evenly reflected by the side surface of the base 610 which does not have the protrusions 660. Meanwhile, the side surface of the LGP 600 which faces the light sources 500 can perform a light guide function normally even if it has the protrusions 660. Therefore, abnormal reflection can be minimized. Accordingly, this can minimize leakage of light caused by the protrusions 660 formed in the LGP 600.

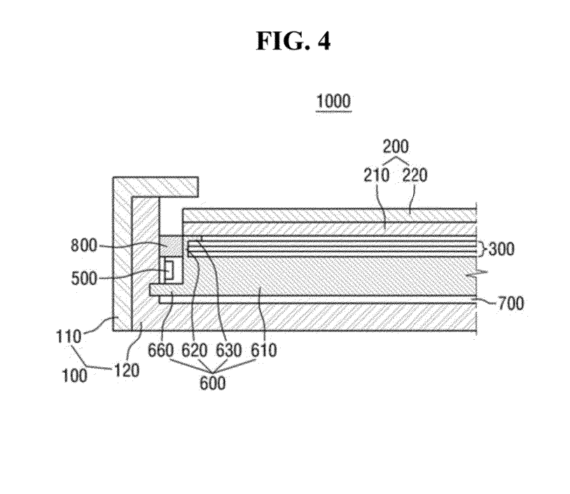

Turning now to FIG. 4, the LGP 600, the optical sheets 300, and the adhesive member 800 will now be described in more detail. FIG. 4 is a cross-sectional view of the display device 1000 taken along the line IV-IV′ of FIG. 1.

Referring now to FIG. 4, the optical sheets 300 may be staked on a region of the surface of the base 610 of the LGP 600 which is surrounded by the sidewalls 620. The number of the optical sheets 300 may be equal to or greater than one. In FIG. 4, three optical sheets 300 are shown, however, the number of the optical sheets 300 is not limited to three, and can instead be greater or smaller than three. The optical sheets 300 may contact the sidewalls 620 of the LGP 600. The optical sheets 300 may contact all or some of the sidewalls 620 of the LGP 600. Preferably, the optical sheets 300 may at least contact a sidewall 620 of the LGP 600 and another sidewall 620 which faces the sidewall 620. Since the optical sheets 300 contact the LGP 600, they can be fixed more securely on the surface of the base 610 of the LGP 600.

A height of the sidewalls 620 of the LGP 600 may be greater than a height to which the optical sheets 300 are stacked. Specifically, the height of the sidewalls 620 of the LGP 600 may be a value obtained by adding the height to which the optical sheets 300 are stacked and a thickness of the covers 630. If a thickness of an air layer between the covers 630 and the optical sheets 300 is taken into consideration, the height of the sidewalls 620 of the LGP 600 may be greater than the value obtained by adding the height to which the optical sheets 300 are stacked and the thickness of the covers 630.

The covers 630 of the LGP 600 may partially overlap the optical sheets 300. Specifically, the covers 630 of the LGP 600 may be formed on the stacked optical sheets 300 to partially cover the optical sheets 300. In addition, the covers 630 of the LGP 600 may overlap the optical sheets 300 at the corners of the LGP 600. An angle formed by each pair of sidewalls 620 a corresponding cover 630 may be a right angle.

The display panel 200 may be placed on the sidewalls 620 and the covers 630 of the LGP 600. Specifically, the upper surfaces of the sidewalls 620 and the covers 630 of the LGP 600 may directly contact a lower surface of the display panel 200. Therefore, since the display panel 200 is supported by the sidewalls 620 and the covers 630 of the LGP 600, a predetermined distance can be maintained between the display panel 200 and the optical sheets 300. In addition, the outer surfaces of the sidewalls 620 of the LGP 600 may be parallel and flush with side surfaces of the display panel 200, wherein flush means that the outer surfaces of the sidewalls 620 may lie in the same plane as the side surfaces of the display panel 200.

The adhesive member 800 may attach the lower housing 120 to at least part of the outer surface of at least one of the sidewalls 620 of the LGP 600. In addition, an upper surface of the adhesive member 800 may be parallel to the upper surface of at least one of the sidewalls 620. Further, the upper surface of the adhesive member 800 may lie in the same plane as the upper surface of the at least one of the sidewalls 620. A lower surface of the adhesive member 800 may contact the light sources 500, however, the lower surface of the adhesive member 800 may preferably be separated from the light sources 500 by more than a predetermined distance. The adhesive member 800 can also be formed integrally with the lower housing 120. Referring back to FIG. 1 which shows a perspective view of the adhesive member 800, the adhesive member 800 is shaped like a rectangular parallelepiped, however, the adhesive member 800 can be manufactured in other various shapes according to the shape of the LGP 600.

The adhesive member 800 not only fixes the LGP 600 to the lower housing 120 as described above, but also directs light coming from the light sources 500 toward the LGP 600. Therefore, the adhesive member 800 may be made of the same material as the reflective sheet 700, and a surface thereof may be coated with an adhesive. Here, the adhesive may be made of a light transmissive material.

In the display device 1000 according to the current first embodiment, the optical sheets 300 are stacked in a space defined by the surface of the base 610 of the LGP 600 and the inner surfaces of the sidewalls 620. Therefore, the optical sheets 300 can be aligned as accurately as desired. In addition, since the base 610, the sidewalls 620, and the covers 630 of the LGP 600 surround the optical sheets 300, the optical sheets 300 can be securely fixed on the surface of the base 610. That is, the optical sheets 300 can be prevented from being moved by external impact or vibration applied to the display device 1000. Accordingly, this prevents the detachment of some of the optical sheets 300 from the LGP 600 and prevents abrasion of the optical patterns formed on a surface of the optical sheets 300, thus ensuring desired optical display quality.

Furthermore, since a mold frame is not used, the display device 1000 can be manufactured slim, and the processing time and cost can be saved because a process of stacking a backlight assembly and the display panel 200 on the mold frame is omitted. Also, the utilization area of the optical sheets 300 and the display panel 200 can be increased. Moreover, since all light emitted from the light sources 500 is directed to the display panel 200 by the LGP 600, the optical sheets 300, the reflective sheet 700 and the adhesive member 800, the light efficiency of the display device 1000 can be increased.

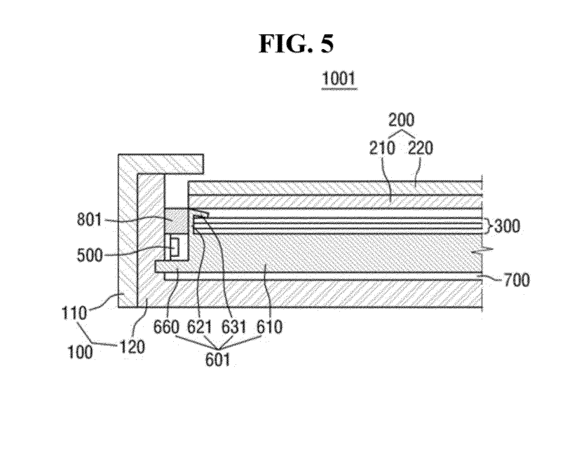

Turning now to FIG. 5, FIG. 5 is a cross-sectional view of a display device 1001 according to another embodiment of the present invention, taken as in FIG. 4. For simplicity, elements substantially identical to those of the display device 1000 shown in FIGS. 1 through 4 are indicated by like reference numerals, and thus a repetitive description thereof will be omitted.

Referring to FIG. 5, a cover 631 of an LGP 601 may protrude from a sidewall 621 of the LGP 601 and may slope downward. That is, an angle formed by the sidewall 621 and the cover 631 may be an acute angle. Therefore, the sidewall 621 of the LGP 601 may be high enough to form an acute angle with the cover 631. Accordingly, a gap between a display panel 200 and one or more optical sheets 300 may be greater when an angle formed by the sidewall 621 and the cover 631 is an acute angle than when an angle formed by a sidewall 620 and a cover 630 is a right angle. In addition, a thickness of an adhesive member 801 may be equal to the height of the sidewall 621 of the LGP 601. An upper surface of the adhesive member 801 may lie in the same plane with an upper surface of the sidewall 621.

The cover 631 may be made out of an elastic member. The optical sheets 300 may be interference-fitted into and stacked in a space surrounded by a base 610, the sidewall 621, and the cover 631. The optical sheets 300 may contact an end of the cover 631. In FIG. 5, the optical sheets 300 contact an end of the cover 631, however, the optical sheets 300 can also contact other portions of the cover 631. For example, if the cover 631 protrudes from the sidewall 621 in a ‘U’ shape, the optical sheets 300 may contact a central portion of the cover 631.

In the display device 1001 according to the current embodiment, the gap between the display panel 200 and the optical sheets 300 can be adjusted by adjusting the height of the sidewall 621 of the LGP 601 according to required optical display characteristics. In addition, since the optical sheets 300 are interference-fitted into the space surrounded by the base 610, the sidewall 621, and the cover 631 which is made of an elastic member, they can be fixed more securely on a surface of the base 610.

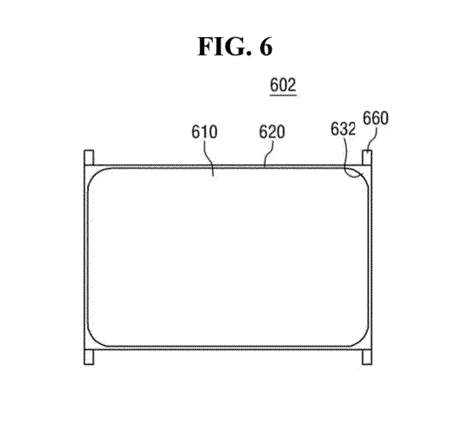

Turning now to FIG. 6, FIG. 6 is a plan view of an LGP 602 according to another embodiment of the present invention. For simplicity, elements substantially identical to those of the display device 1000 shown in FIG. 3 are indicated by like reference numerals, and thus a repetitive description thereof will be omitted.

Referring to FIG. 6, an inner end of each cover 632 may be curved toward a corresponding sidewall 620 of the LGP 602. That is, as seen from a center of the base 610 of the LGP 602, the cover 632 has a concave curve. That is, an exposed region of a base 610 seen in the plan view of the LGP 602 may be shaped like a quadrilateral, and corners of the quadrilateral may be curved.

In the LGP 602 according to the current embodiment, the exposed region of the base 610 seen in the plan view of the LGP 602 is a region that light emitted inside a display device evenly reaches. Therefore, uniform display quality can be obtained by increasing the area of the exposed region of the base 610 seen in the plan view of the LGP 602.

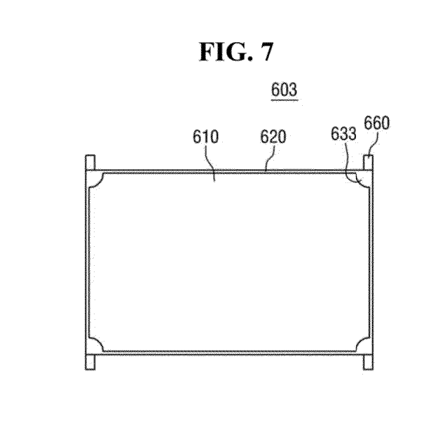

Turning now to FIG. 7, FIG. 7 is a plan view of an LGP 603 according to another embodiment of the present invention. For simplicity, elements substantially identical to those of the display device 1000 shown in FIG. 3 are indicated by like reference numerals, and thus a repetitive description thereof will be omitted.

Referring to FIG. 7, an inner end of each cover 633 may be curved toward a center of the LGP 603. That is, as seen from a center of the base 610 of the LGP 603, the cover 633 has a convex curve.

In the LGP 603 according to the current embodiment, one or more optical sheets 300 can be fixed more securely on a surface of a base 610 by increasing the area of each cover 633.

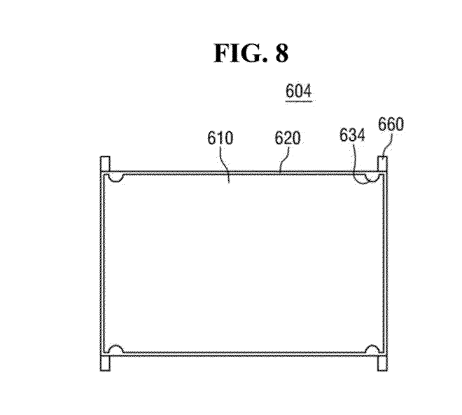

Turning now to FIG. 8, FIG. 8 is a plan view of an LGP 604 according to another embodiment of the present invention. For simplicity, elements substantially identical to those of the display device 1000 shown in FIG. 3 are indicated by like reference numerals, and thus a repetitive description thereof will be omitted.

Referring to FIG. 8, cover portions 634 of the LGP 604 may protrude from two opposing sidewalls 620 of the LGP 604. In addition, the covers 634 as seen on a surface of a base 610 of the LGP 604 may be semi-circular.

In the LGP 604 according to the current embodiment, one or more optical sheets 300 can be inserted into spaces between the covers 634 and sidewalls 620 which are adjacent to the covers 634 and do not have the covers 634. Therefore, the LGP 604 and the optical sheets 300 can be assembled easily.

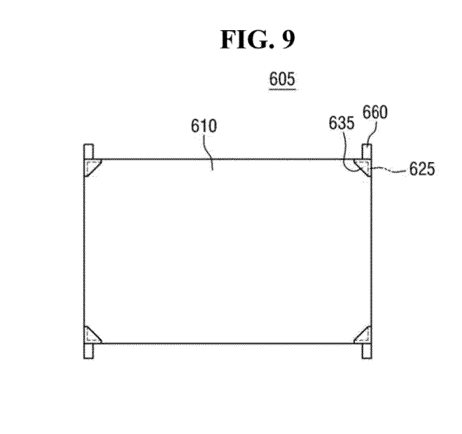

Turning now to FIG. 9, FIG. 9 is a plan view of an LGP 605 according to another embodiment of the present invention. For simplicity, elements substantially identical to those of the display device 1000 shown in FIG. 3 are indicated by like reference numerals, and thus a repetitive description thereof will be omitted.

Referring to FIG. 9, sidewalls 625 and covers 635 of the LGP 605 may be formed only at corners of the LGP 605. As a result and unlike the arrangement of FIG. 3, the sidewalls 625 in the embodiment of FIG. 9 do not extend along a length of an edge of base 610 but are only formed at corners of base 610.

In the LGP 605 according to the current embodiment, one or more optical sheets 300 can be securely fixed in position by the sidewalls 625 and the covers 635 formed at the corners of the LGP 605, and material costs required to form the sidewalls 625 of the LGP 605 can be reduced.

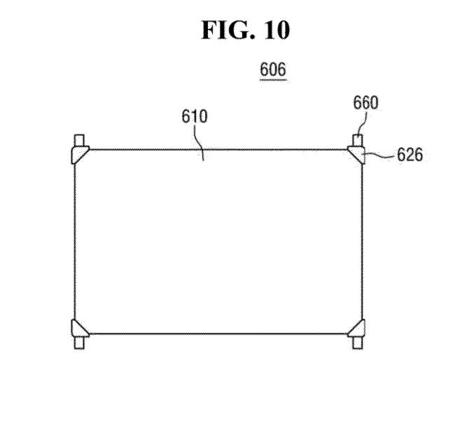

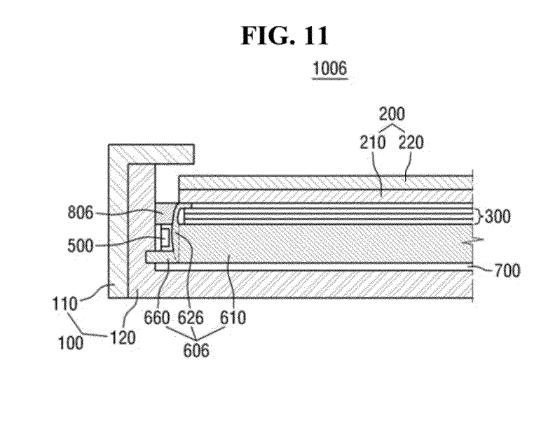

Turning now to FIGS. 10 and 11, FIG. 10 is a plan view of an LGP 606 according to another embodiment of the present invention and FIG. 11 is a cross-sectional view of a display device 1006 according to another embodiment of the present invention, taken as in FIG. 4. For simplicity, elements substantially identical to those of the display device 1000 shown in FIGS. 3 and 4 are indicated by like reference numerals, and thus a repetitive description thereof will be omitted.

Referring to FIGS. 10 and 11, the display device 1006 according to the current embodiment includes the LGP 606 and a display panel 200 disposed on the LGP 606. The LGP 606 includes a base 610 and sidewalls 626 which protrude from ends of the base 610. The sidewalls 626 may extend from the ends of the base 610 to be bent toward a center of the base 610. Here, each end of the base 610 may include an edge portion of a surface of the base 610 and a side surface of the base 610. Referring to FIG. 10, when seen in the plan view of the LGP 606, the sidewalls 626 may protrude from side surfaces of the base 610 in a direction away from the base 610. In FIG. 10, the sidewalls 626 are formed only at corners of the LGP 606, however, the present invention is not limited thereto, as the sidewalls 626 can instead be formed at all ends of the LGP 606. The sidewalls 626 of the LGP 606 may protrude upward in a ‘C’ shape. In FIG. 11, the sidewalls 626 are formed in a ‘C’ shape, however, the present invention is not limited thereto, as the sidewalls 626 can instead be formed in a ‘ [symbol] ’ shape. The base 610 and the sidewalls 626 may be formed integrally with each other.

Referring to FIG. 11, the display device 1006 according to the current embodiment may further include one or more optical sheets 300 stacked on a region of the surface of the base 610 which is surrounded by the sidewalls 626. Here, the sidewalls 626 may at least partially overlap the optical sheets 300. In addition, an adhesive member 806 is formed in a shape corresponding to the shape of at least one side surface of the LGP 606 such that it can be attached to at least part of an outer surface of at least one of the sidewalls 626 of the LGP 606.

In the display device 1006 according to the current embodiment, the optical sheets 300 can be securely fixed on the surface of the base 610 of the LGP 606. In addition, the LGP 606 which can securely fix the optical sheets 300 in position can be manufactured simply by deforming edges of the LGP 606 using, for example heat to form the sidewalls 626 which extend from the base 610 and are bent toward the center of the base 610.

Embodiments of the present invention provide at least one of the following advantages. Desired optical display quality can be ensured by accurately aligning and securely fixing optical sheets on an LGP as desired. In addition, a display device can be manufactured to be slim, the processing time and expenses can be saved by omitting a process of stacking elements on a mold frame, and the utilization area of the optical sheets and a display panel can be increased.

While the present invention has been particularly shown and described with reference to exemplary embodiments thereof, it will be understood by those of ordinary skill in the art that various changes in form and details may be made therein without departing from the spirit and scope of the present invention as defined by the following claims. It is therefore desired that the present embodiments be considered in all respects as illustrative and not restrictive, reference being made to the appended claims rather than the foregoing description to indicate the scope of the invention.

What is claimed is:

1. A display device, comprising:
a light guide plate (LGP) including a base, a plurality of sidewalls that protrude from a surface of the base, and a plurality of covers that protrude towards a center of the base; and
a display panel arranged on the LGP.

2. The display device of claim 1, wherein the base has a rectangular shape, and the plurality of sidewalls protrude upward from edges of the surface of the base.

3. The display device of claim 2, wherein the plurality of covers are arranged at locations corresponding to corners of the base.

4. The display device of claim 2, further comprising at least one light source arranged to face at least one side surface of the base, wherein the LGP further comprises at least one protrusion that protrudes toward the at least one light source.

5. The display device of claim 4, wherein each of the at least one protrusion is arranged at a corresponding corner of the base.

6. The display device of claim 1, wherein the plurality of sidewalls are perpendicular to the surface of the base.

7. The display device of claim 1, wherein the plurality of covers extend parallel to the surface of the base.

8. The display device of claim 1, further comprising at least one optical sheet stacked on the surface of the base.

9. The display device of claim 8, wherein the at least one optical sheet contacts the plurality of sidewalls.

10. The display device of claim 8, wherein a height of each of the plurality of sidewalls is greater than a height of the at least one optical sheet.

11. The display device of claim 8, wherein the at least one optical sheet is at least partially overlapped by the plurality of covers.

12. The display device of claim 11, wherein the at least one optical sheet contacts at least a portion of each of the plurality of covers.

13. The display device of claim 1, further comprising:
a housing accommodating the display panel and the LGP; and
an adhesive member attaching the LGP to the housing.

14. The display device of claim 13, wherein the adhesive member is attached to at least a part of an outer surface of at least one of the plurality of sidewalls.

15. The display device of claim 1, wherein the base, the plurality of sidewalls, and the plurality of covers are formed integrally with each other.

16. A display device, comprising:
a light guide plate (LGP) including a base and a plurality of sidewalls that protrude from edges of the base and are also bent towards a center of the base; and
a display panel arranged on the LGP.

17. The display device of claim 16, wherein the plurality of sidewalls protrude upward in a ‘C’ shape.

18. The display device of claim 16, further comprising at least one optical sheet arranged on a surface of the base that is surrounded by the plurality of sidewalls.

19. The display device of claim 18, wherein the plurality of sidewalls at least partially overlap the at least one optical sheet.

20. A light guide plate (LGP), comprising:
a base;
a plurality of sidewalls protruding from a surface of the base; and
a plurality of covers protruding from the plurality of sidewalls toward a center of the base.
